(19) United States
(12) Patent Application Publication
(10) Pub. No.: US 2006/0012981 A1
(43) Pub. Date: Jan. 19, 2006

(54) Fluorescent lighting fixtures

(76) Inventor: Shi Youl Noh, Kyonggi-do (KR)

Correspondence Address: Joseph Hyosuk Kim, Ph.D.;JHK Law, P.O. Box 1078, La Canada, CA, 91012-1078, US

(21) Appl. No.: 10/895,475

(22) Filed: Jul. 19, 2004

(51) Int. Cl. F21S 4/00

(52) U.S. Cl. 362/217

(57) ABSTRACT

The present invention relates to fluorescent lighting fixtures, which are aligned in series at regular intervals, which are easily connected one another, and which prevent discontinuation of illumination occurring between fluorescent lamps. The fluorescent lighting fixture includes: a fluorescent lamp having a tube type lamp body, auxiliary tubes mounted at the tops of both ends of the lamp body, and terminal pins inwardly formed at an end of each auxiliary tube; a body having a stabilizer mounted therein for lighting the fluorescent lamp, connection terminals located at both ends thereof at a predetermined interval and electrically connected with the stabilizer; and sockets mounted at both ends of the body, each of the sockets having a support slit formed in the outer surface thereof for fixing and supporting the terminal pins of the fluorescent lamp, and a receiving slit for allowing the terminal pins to be inserted into the support slit.

### BACKGROUND OF THE INVENTION

1. Field of the Invention

The present invention relates to fluorescent lighting fixtures, and more particularly, to fluorescent lighting fixtures, which are aligned in series at regular intervals, which are more easily connected to one another, and which prevent discontinuation of illumination occurring between fluorescent lamps.

In addition, the present invention relates to a fluorescent lamp socket having an improved socket structure, which allows for an easy mounting of the fluorescent lamp, and which can restrict rotation of the fluorescent lamp after the mounting to prevent separation of the fluorescent lamp from the socket, thereby preventing an unexpected accident and reducing damage of the fluorescent lamp.

2. Background of the Related Art

As shown in FIG. 1, a fluorescent lamp 20, which has been used till now, has terminal pins 21 mounted at both ends thereof, and the fluorescent lamp 20 is mounted to a fluorescent lighting fixture 1 to provide illumination.

Recently, the fluorescent lamp 20 has an ornamental effect for providing a visual effect by being mounted in a display room or a show room of a shop as well as an effect for simply emitting light. Therefore, compact and slim fluorescent lamps 20 of the smallest sectional area have been widely used in order to occupy the smallest area.

Furthermore, the plural slim fluorescent lamps 20 are connected with one another in series and used.

The structure and the connected form of the slim fluorescent lamps 20 will not be described in the present invention because they are described in detail in Korean Patent No. 221195 (entitled “fluorescent lamp”), which was filed by the same applicant of the present invention.

Moreover, recently, such fluorescent lamps 20, each of which has a small diameter, are used for indirect illumination or ornamental illumination as well as the direct illumination.

Such a fluorescent lamp 20 requires a body 2 of a fluorescent lighting fixture, which has sockets 10 mounted at both ends thereof for assembling the fluorescent lamp 20, and the body 2 includes a circuit board or other necessary parts and a stabilizer (not shown) for lighting the fluorescent lamp 20.

The fluorescent lamp 20 is assembled to the body 2 in such a way that the terminal pins 21 of the fluorescent lamp 20 are simply inserted into the sockets 10.

However, in the case where the plurality of the fluorescent lighting fixtures 1 are used according to the use purpose, in a process of connecting and mounting the fluorescent lighting fixtures 1 in series, there are formed regular intervals between the neighboring fluorescent lamps 20 due to the sockets 10 for fixing the terminal pins 21 of the fluorescent lamps 20.

As described above, when the fluorescent lighting fixtures 1 are connected with one another in series, there are formed the regular intervals between the fluorescent lamps 20, and it causes discontinuation of illumination, and hence, the conventional fluorescent lighting fixtures cannot provide the perfect illumination effect.

Meanwhile, to solve the above problem, there has been used an easy method of aligning the fluorescent lighting fixtures 1 in a little zigzag by overlapping the connected portions. But, in this case, the conventional method has a problem in that illumination is distorted since the fluorescent lamps 20 are not aligned in a line.

Furthermore, the socket 10 includes a socket body 11 fixed to the body 2 of the fluorescent lighting fixture 1, an insertion hole 12 formed at a side of the socket body 11, and a receiving slit 13 formed at the lower end of the insertion hole 12 for allowing the terminal pin 21 of the fluorescent lamp 20 to be inserted into the insertion hole 12.

The socket body 11 includes a pair of contact terminals 14 mounted therein at a fixed interval for electrically connecting the socket 10 with the stabilizer (not shown) so as to supply power source to the fluorescent lamp 20, and the contact terminals 14 have elasticity.

The contact terminal 14 has a receiving slot 14a for receiving the terminal pin 21 of the fluorescent lamp 20.

Therefore, the fluorescent lamp 20 is assembled between the sockets 10 coupled to both ends of the body 2 of the fluorescent lighting fixture. At this time, after the terminal pins 21 of the fluorescent lamp 20 are inserted into the insertion holes 12 through the receiving slits 13 of the socket bodies 11, the fluorescent lamp 20 is rotated at an angle of about 90? and fixed to the sockets 10.

That is, when the fluorescent lamp 20 is rotated at the angle of 90?, the terminal pins 21 spread the contact terminals 14 to both sides, and at the same time, the terminal pins 21 are inserted into the receiving slots 14a of the contact terminals 14, so that the fluorescent lamp 20 is completely assembled.

However, because the bottom end of the socket body 11 is always opened by the receiving slit 13, if the fluorescent lamp 20 is assembled errorneously or elasticity of the contact terminal 14 is deteriorated due to a long-term use, the terminal pins 21 of the fluorescent lamp 20 may be separated from the socket 10 through the receiving slit 13.

Moreover, when the fluorescent lamp 20 is separated from the socket 10, it may cause an unexpected accident as well as damage of the fluorescent lamp 20.

### SUMMARY OF THE INVENTION

Accordingly, the present invention has been made to solve the above problems, and it is an object of the present invention is to provide fluorescent lighting fixtures, which can be aligned regularly and in series, and prevent any intervals from being formed between fluorescent lamps, thereby providing beautiful outward appearance, increasing the illumination effect, and improving an connection structure more firmly.

Another object of the present invention is to provide fluorescent lighting fixtures, which can provide easy assembly and disassembly of the fluorescent lamps and maintain a stably fixed condition of the fluorescent lamps after the assembly, thereby preventing an unexpected accident and reducing damage of the fluorescent lamps by preventing separation of the fluorescent lamps.

To achieve the above objects, according to the present invention, there is provided a fluorescent lighting fixture including: a fluorescent lamp having a tube type lamp body, auxiliary tubes mounted at the tops of both ends of the lamp body, and terminal pins formed at an end of each auxiliary tube inwardly; a body having a stabilizer mounted therein for lighting the fluorescent lamp, connection terminals located at both ends thereof at a predetermined interval and electrically connected with the stabilizer; and sockets mounted at both ends of the body, each of the sockets having a support slit formed in the outer surface thereof for fixing and supporting the terminal pins of the fluorescent lamp, and a receiving slit for allowing the terminal pins to be inserted into the support slit.

In another aspect of the present invention, there is also provided a fluorescent lamp socket including: a main body; first bodies connected with a stabilizer by electric wires;, second bodies fixed to both ends of the main body in a state where each second body contains each first body therein, the second body having a support slit formed at a side thereof for fixing and supporting the terminal pins of a fluorescent lamp, and a receiving slit inclinedly formed at a side of the support slit for allowing the terminal pins of the fluorescent lamp to be inserted into the support slit; and contact means mounted in a mounting hole formed in the first body in a state where the contact means is connected with the electric wires, and elastically connected with the terminal pins.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG.1 is a perspective view of a conventional fluorescent lighting fixture;

FIG. 2 is a perspective view of a fluorescent lighting fixture according to a preferred embodiment of the present invention;

FIG. 3 is an exploded perspective view of the fluorescent lighting fixture according to the present invention;

FIG. 4 is a perspective view of a modification of a connector according to the present invention;

FIGS. 5 and 6 are perspective views of modifications of a fluorescent lamp according to the present invention;

FIG. 7 is a perspective view of a modification of a socket of the fluorescent lighting fixture according to the present invention;

FIG. 8 is an exploded perspective view showing an exploded state of the socket of FIG. 7;

FIGS. 9a to 9c are assembly diagrams showing a state where the fluorescent lamp is assembled to the socket of FIG. 7; and

FIG. 10 is a perspective view of another modification of the socket, showing a state where the socket is mounted to the fluorescent lighting fixture in such a way that a support slit and a receiving slit are directed inwardly.

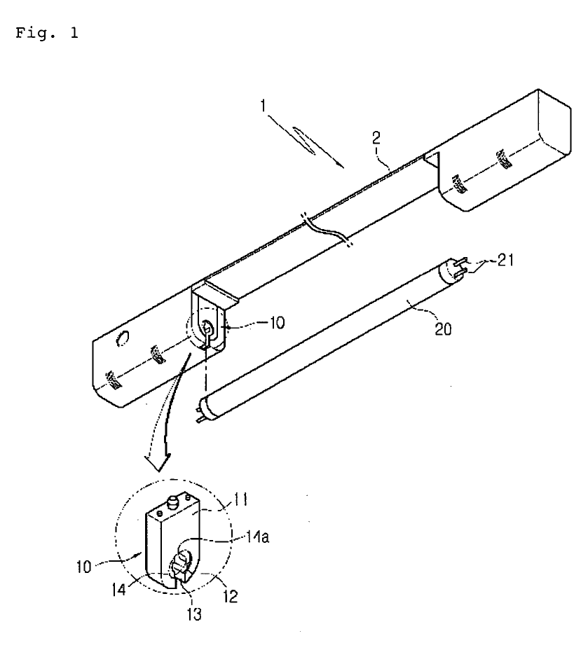

### DETAILED DESCRIPTION OF THE PREFERRED EMBODIMENT

Reference will now be made in detail to the preferred embodiments of the present invention, examples of which are illustrated in the accompanying drawings.

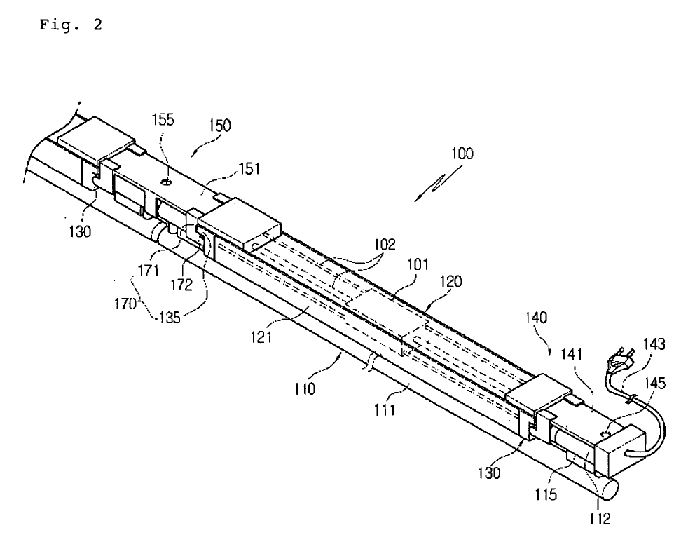

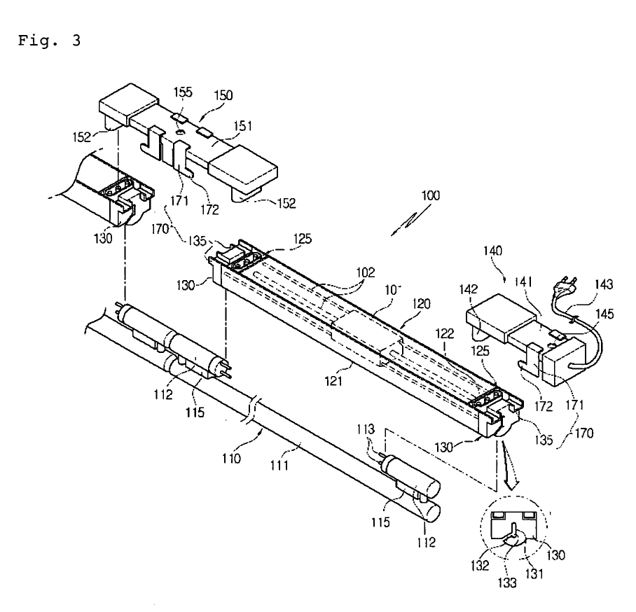

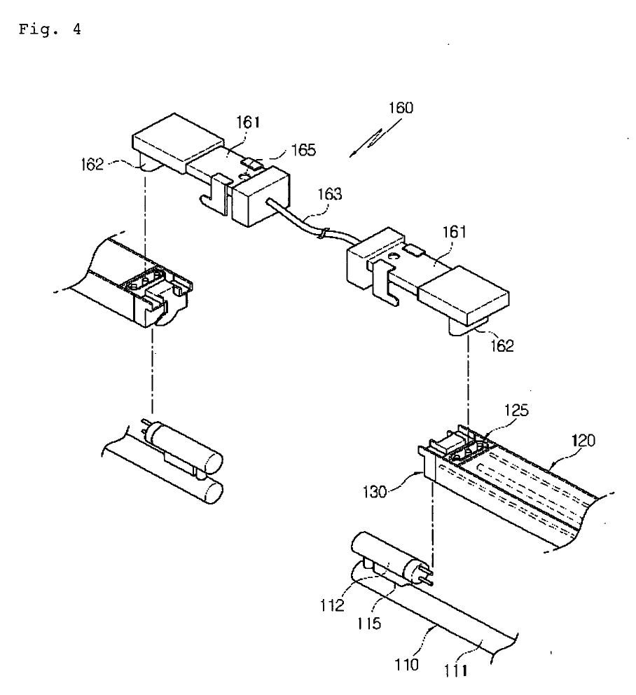

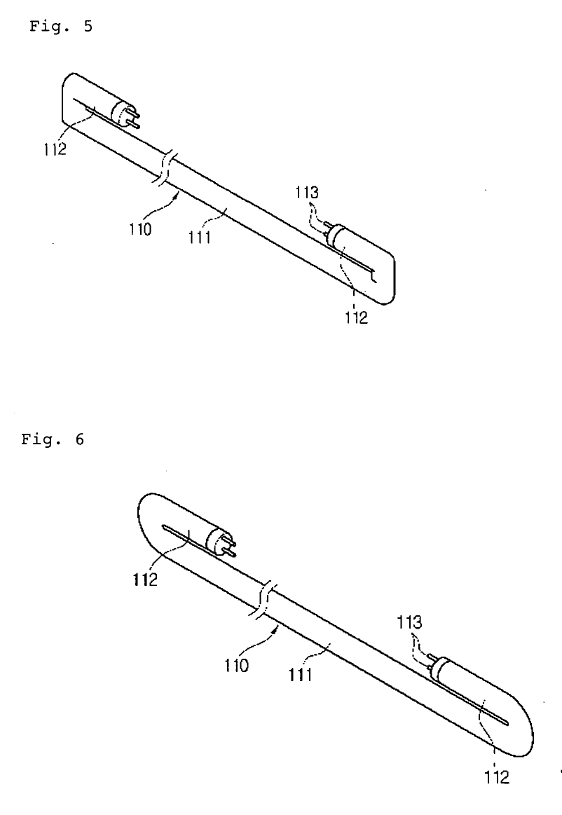

FIG. 2 is a perspective view of a fluorescent lighting fixture according to a preferred embodiment of the present invention, FIG. 3 is an exploded perspective view of the fluorescent lighting fixture according to the present invention, FIG. 4 is a perspective view of a modification of a connector according to the present invention, and FIGS. 5 and 6 are perspective views of modifications of a fluorescent lamp according to the present invention.

As shown in the drawings, the fluorescent lighting fixture 100 according to the present invention includes a fluorescent lamp 110, a body 120 bent in a predetermined shape and serving as a reflection plate, and sockets 130 connected and fixed at both ends of the body 120 for supplying power source to the fluorescent lamp 110.

First, the fluorescent lamp 110 includes a tube type lamp body 111, auxiliary tubes 112 mounted at the tops of both ends of the lamp body 111, and terminal pins 113 formed at an end of each auxiliary tube 112 inwardly.

The detailed description of the fluorescent lamp 110 will be omitted as the fluorescent lamp 110 is disclosed in Korean Patent Application No. 10-2003-0085196 (filed on Nov. 27, 2003, and entitled “fluorescent lamp”), which was filed by the same applicant of the present invention.

That is, the plurality of the fluorescent lamps 110 can be closely aligned with no intervals between the fluorescent lamps 110 even though the fluorescent lighting fixtures 100 are aligned in series.

Meanwhile, a reinforcing bracket 115 is mounted between the lamp body 111 and the auxiliary tube 112 in order to maintain an interval between the lamp body 111 and the auxiliary tube 112 and to prevent damage of the auxiliary tube 112 by supporting the auxiliary tube 112.

Next, the body 120 of the fluorescent lighting fixture includes a reflection plate 121, and a cover 122 for covering the opened upper end portion of the reflection plate 121. A typical stabilizer 101 is mounted inside the body 120 for lighting the fluorescent lamp 110 by receiving the external power source.

In addition, the body 120 further includes connection terminals 125 mounted at both ends thereof and separated from each other at a predetermined interval so as to be electrically connected with the stabilizer 101 by an electric wire 102.

The socket 130 includes a contact terminal (not shown) mounted therein and connected with the stabilizer 101 by the electric wire 102, a support slit 131 formed in the outer surface thereof for fixing and supporting the terminal pins 113 of the fluorescent lamp 110, and a receiving slit 132 inclinedly formed at a side of the support slit 131 for allowing the terminal pins 113 to be inserted into the support slit 131.

Here, it is preferable that the support slit 131 is formed vertically, and the receiving slit 132 communicates with the support slit 131 and inclined downwardly at a predetermined angle.

Furthermore, it is preferable that the receiving slit 132 is formed from the bottom of the support slit 131 to a predetermined height, and has a recess portion 133 formed between the receiving slit 132 and the lower end of the support slit 131.

That is, after the terminal pins 113 of the fluorescent lamp 110 are assembled to the support slits 131 of the sockets 130, rotation of the fluorescent lamp 110 is prevented by the recess portions 133 of the sockets 130, so that the fluorescent lamp 110 cannot be easily separated from the sockets 130 to prevent an unexpected accident and damage of the fluorescent lamp 110.

The contact terminal is not shown in the drawings, but includes the upper terminal and the lower terminal. When the terminal pins 113 of the fluorescent lamp 110 are inserted and seated into the support slits 131 of the sockets 130, the contact terminals are resiliently connected with the terminal pins 113 and supply power source from the stabilizer 101 to the fluorescent lamp 110.

Various connectors 140, 150 and 160 can be coupled with the connection terminals 125 of the fluorescent lighting fixture 100 so as to receive the external power source or to continuously connect the plural fluorescent lighting fixtures 100.

FIGS. 3 and 4 show the connectors 140, 150 and 160, and they will be described in detail as follows.

First, the connector 140 for supplying the external power source to the stabilizer 101 of the fluorescent lighting fixture 100 includes a connector body 141, a coupling terminal 142 protruding downwardly from an end of the body 141 to be coupled with the connection terminal 125, and a power cord 143 of a predetermined length mounted at the other end of the body 141.

In the case where the plurality of the fluorescent lighting fixtures 100 are continuously connected one another, the connector 150 for supplying power source by connecting neighboring connection terminals 125 with each other is used. The connector 150 includes a connector body 151 of a predetermined length, and coupling terminals 152 protruding downwardly from both ends of the body 151.

Moreover, FIG. 4 shows the connector 160, which is used for continuously connecting the fluorescent lighting fixtures 100 but formed differently from the connector 150. The connector 160 includes a pair of separate bodies 161 for connecting the neighboring connection terminals 125 with each other and supplying power source, coupling terminals 162 respectively protruding from ends of the bodies 161 in the downward direction, and an electric wire 163 of a predetermined length for connecting the other ends of the bodies to each other.

Meanwhile, since the connection terminals 125 are mounted on the inner bottoms of the sockets 130 mounted at both ends of the body 120 without exposure to the outside and the body 120 can be disassembled vertically from the connector, the body 120 of the fluorescent lighting fixture can be easily assembled and disassembled.

That is, the body 120 can be easily replaced in such a way that the connection terminals 125 are simply coupled with the coupling terminals 142, 152 or 162 of the connectors 140, 150 or 160 in the vertical direction fixed on the ceiling.

In order to combine the connection terminals 125 of the body 120 with the connector 140, 150 or 160 without separation, combining means 170 is provided.

The combining means 170 includes support jaws 135 protruding outwardly from a side of the socket 130, and combining parts 171 slidably coupled with the connector body 141, 151 or 161 of the connector 140, 150 or 160 and respectively having locking jaws 172. The locking jaw 172 is formed at a side of the combining part 171 and matched with the support jaw 135.

The connector body 141, 151 or 161 of the connector 140, 150 or 160 further includes a fixing hole 145, 155 or 165 for fixing the fluorescent lighting fixture 100 on the ceiling.

Meanwhile, besides the connector 140, 150 or 160, an electric wire can be connected between the bodies 120 of the fluorescent lighting fixtures for supplying power source. At this time, each of the sockets 130 mounted at both ends of the body 120 has a path (not shown) for the connection of the electric wire.

FIGS. 5 and 6 are perspective views showing a modification of the fluorescent lamp 110 according to the present invention. As shown in the drawings, the lamp body 111 is bent at both ends in such a way that the terminal pins 113 are directed inwardly. At this time, it is preferable that the lamp body 111 and the auxiliary tube 112 are arranged horizontally.

The fluorescent lamp 110 is shown as an example, and can be modified in various forms.

Hereinafter, the function of the fluorescent lighting fixture 110 according to the present invention will be described.

First, the fluorescent lamp 110 is simply assembled with the sockets 130 by locating the terminal pins 113 inside the support slits 131 of the sockets 130 after inserting the terminal pins 113 of the fluorescent lamp 110 along the inclined receiving slits 132 of the sockets 130.

That is, when the terminal pins 113 of the fluorescent lamp 110 are inserted into the support slit 131 along the receiving slit 132, the stabilizer 101 and the fluorescent lamp 110 are electrically connected with each other while the terminal pins 113 are in elastic contact with the contact terminals of the sockets 130, so that the fluorescent lamp 110 can receive power source from the stabilizer 101.

Moreover, the terminal pins 113 of the fluorescent lamp 110 are stably seated on the bottoms of the support slits 131, and then, rotation of the terminal pins 113 is prevented by the recess portions 133 of the sockets 130.

In order to disassemble the fluorescent lamp 110 from the sockets 130, after the fluorescent lamp 110 is lifted upwardly in such a way that the terminal pins 113 are located on the upper portion of the inside of the support slits 131, the fluorescent lamp 110 is rotated at a predetermined angle, and the terminal pins 113 are drawn out through the receiving slits 132, so that the fluorescent lamp 110 can be easily disassembled from the sockets 130.

Furthermore, in order to continuously connect the fluorescent lighting fixtures 100 in series, the connection terminals 125 formed at both ends of the body 120 of each fluorescent lighting fixture 100 are simply connected to the connector 140, 150 or 160. After the connection, the combining members 171 are slid toward the sockets 130 so as to match the locking jaws 172 of the combining members 171 with the support jaws 135 of the sockets 130. As a result, the body 120 of the fluorescent lighting fixture is firmly fixed to the connector 140, 150 or 160, and thereby, the fluorescent lighting fixtures 100 connected in series are connected and fixed more firmly.

Referring to the drawings, the socket used in the fluorescent lighting fixture of the present invention or used in the conventional fluorescent lighting fixture will be described in detail.

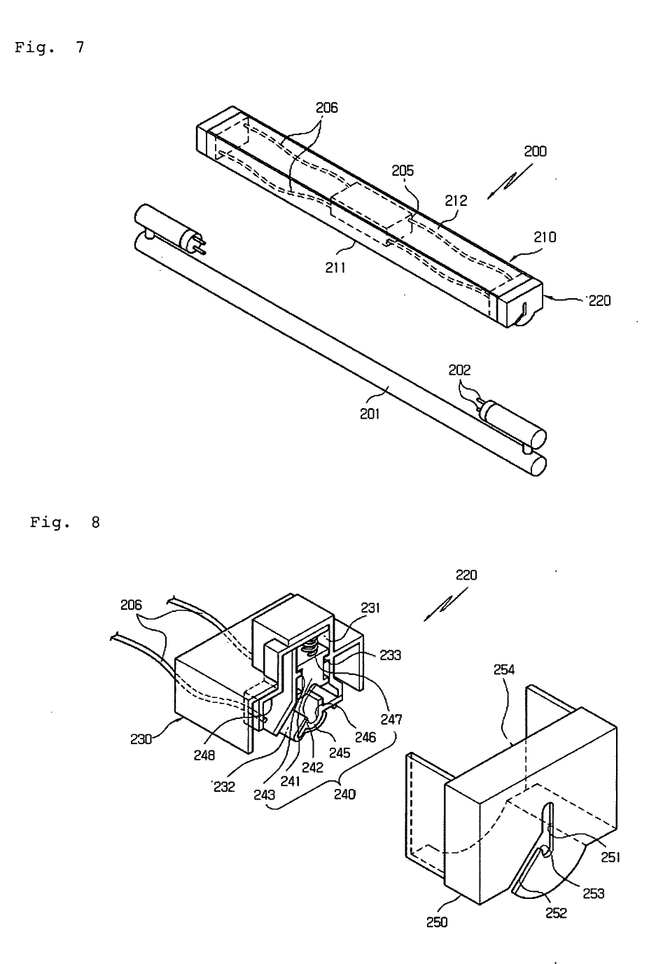

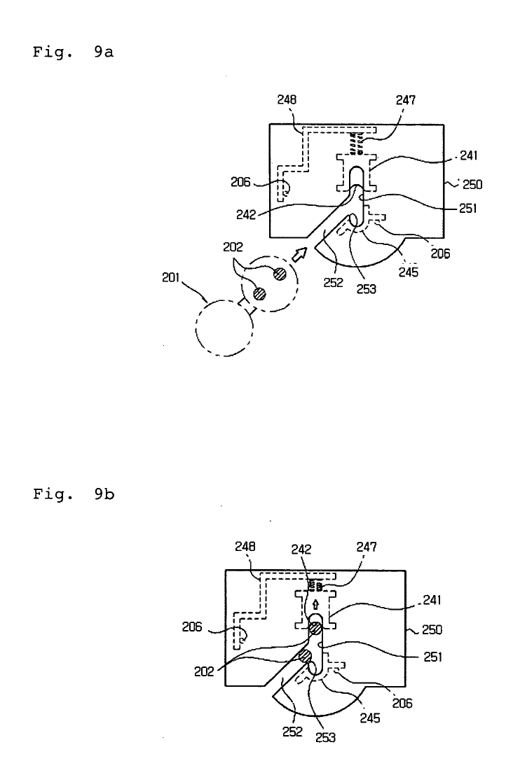

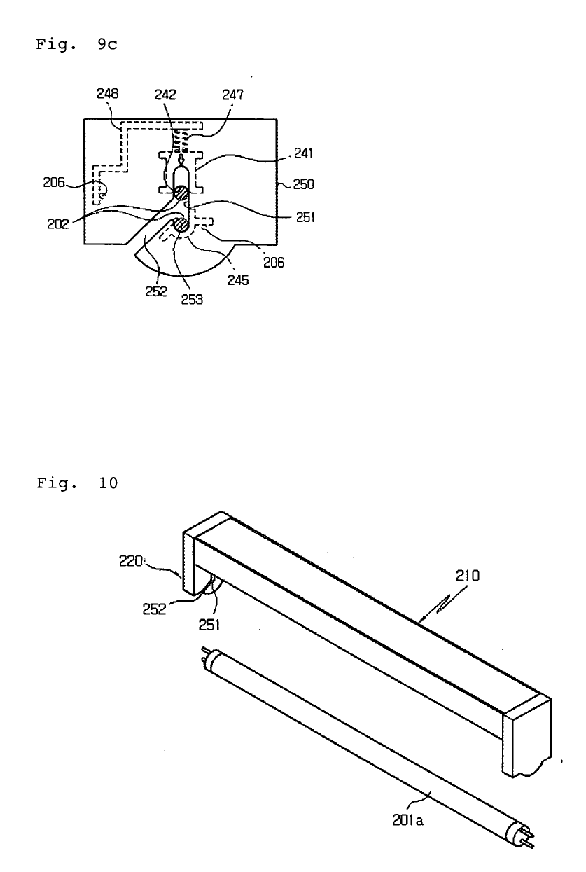

First, as shown in FIG. 7, a fluorescent lighting fixture 200, which is a basic form of the present invention, includes a body 210 bent in a predetermined form and serving as a reflection plate, sockets 220 fixed to both ends of the body 210 for supplying power source, and a fluorescent lamp 201 having both ends fixed to the sockets 220 and lighted by receiving power source from the sockets 220.

Here, the body 210 of the fluorescent lighting fixture 200 includes a reflection plate 211, a cover 212 for covering the opened top of the reflection plate 211, and a stabilizer 205 mounted therein for receiving the external power source.

Moreover, the fluorescent lamp 201 has a pair of terminal pins 202 mounted at each side thereof for receiving power source through the sockets 220.

In the fluorescent lighting fixture 200, the socket 220 includes: a main body 210; first bodies 230 connected with a stabilizer 205 by electric wires 206; second bodies 250 fixed to both ends of the main body 210 in a state where each second body 250 contains each first body 230 therein; and contact means 240 mounted in a mounting hole 231 formed in the first body 230 in a state where the contact means 240 is connected with the electric wires 206, and elastically connected with the terminal pins 202.

The second body 250 includes a support slit 251 formed at a side thereof for fixing and supporting the terminal pins 202 of the fluorescent lamp 201, and a receiving slit 252 inclinedly formed at a side of the support slit 251 for allowing the terminal pins 202 of the fluorescent lamp 201 to be inserted into the support slit 251.

Here, it is preferable that the support slit 251 is formed vertically, and the receiving slit 252 communicates with the support slit 251 and is inclined downwardly at a predetermined angle.

Moreover, the receiving slit 252 is formed from the bottom of the support slit 251 to a predetermined height, and a recess portion 253 is formed between the receiving slit 252 and the lower end of the support slit 251.

That is, after the terminal pins 202 of the fluorescent lamp 201 are inserted and seated into the support slit 251, rotation of the fluorescent lamp 201 is prevented by the recess portion 253.

In addition, the second body 250 has a coupling hole 254 formed in the other side thereof for receiving the first body 230.

Meanwhile, it is preferable that the maximum length of the support slit 251 is larger than a distance between the pairs of the terminal pins 202.

The contact means 240 includes a lower terminal 245 fixed to the lower end of the mounting hole 231, and an upper terminal 241 separated from the lower terminal 245 at a predetermined interval and vertically moving by means of an elastic member 247 mounted on the upper end of the mounting hole 231.

Here, the lower and upper terminals 245 and 241 are electrically connected with the electric wires 206 connected with the stabilizer 205. At this time, the upper terminal 241 is bent in a predetermined form in such a way to electrically the elastic member 247 with one of the electric wires 206, and electrically connected with the stabilizer 205 by means of a connection plate 248 fixed to the first body 230.

Furthermore, the mounting hole 231 has support jaws 233 formed at both sides thereof, and the upper terminal 241 has locking jaws 243 formed at both ends thereof to be caught by the support jaws 233 and to maintain the predetermined interval from the lower terminal 245.

The lower terminal 245 and the upper terminal 241 respectively have receiving recesses 246 and 242 formed on the corresponding surfaces thereof for receiving the terminal pins 202 of the fluorescent lamp 201.

Furthermore, the first body 230 has a receiving slit 232 formed at the corresponding position of the receiving slit 252 of the second body 250 for receiving the terminal pins 202 of the fluorescent lamp 201 between the lower terminal 245 and the upper terminal 241 mounted in the mounting hole 231.

It is preferable that the support slit 251 and the receiving slit 252 are directed outwardly, when the second bodies 250 containing the first bodies 230 are coupled with the both ends of the main body 210.

Meanwhile, as shown in FIG. 10, the structure of the socket 220 can be modified in such a way that the support, slit 251 and the receiving slit 252 are directed inwardly, and in this case, a typical fluorescent lamp 201a can be assembled to the socket 220.

As described above, because the support slit 251 and the receiving slit 252 of the second body 250 can be directed inwardly or outwardly according to the direction of the terminal pins 202 of the fluorescent lamp 201, fluorescent lamps 201 and 201a of various forms can be assembled.

Meanwhile, it is preferable that the elastic member 247 is a spring.

Hereinafter, the function of the socket according to the present invention will be described.

First, the contact means 240 is mounted in the mounting hole 231 of the first body 230, and at this time, the contact means 240 is electrically connected with the stabilizer 205 by the electric wires 206. The first body 230 in which the contact means 240 is mounted is inserted and contained in the coupling hole 254 of the second body 250.

At this time, the receiving slit 232 of the first body 230 and the receiving slit 252 of the second body 250 are in correspondence with each other, and the terminal pins 202 of the fluorescent lamp 201 are inserted into the support slit 251.

After the first body 230 is contained in the second body 250, the socket 220 is completely assembled by coupling the second bodies 250 to both ends of the main body 210.

After that, the fluorescent lamp 201 is assembled to the socket 220. The terminal pins 202 of the fluorescent lamp 201 are pushed along the inclined receiving slit 252 of the second body 250, and the terminal pins 202 are located inside the support slit 251, so that the fluorescent lamp 201 is completely assembled.

That is, when the terminal pins 202 of the fluorescent lamp 201 are inserted into the support slit 251 along the receiving slit 252, the terminal pins 202 are in contact with the upper terminal 241, and at the same time, inserted into the support slit 251 while moving the upper terminal 241 upwardly to a predetermined distance. As described above, when the terminal pins 202 are inserted into the support slit 251, the terminal pins 202 are in close contact with the lower end of the support slit 251 while the upper terminal 241 is lowered by elastically restoring force of the elastic member 247. At this time, the terminal pins 202 are in contact with the upper terminal 241 and the lower terminal 245.

Moreover, the upper terminal 241 continuously presses the terminal pins 202 in the downward direction by the elastic force, and thereby, the terminal pins 202 of the fluorescent lamp 201 can be safely seated on the lower end of the support slit 251. After that, the rotation of the terminal pins 202 is prevented by the recess portion 253.

To disassemble the fluorescent lamp 201 from the socket 220, when the fluorescent lamp 201 is lifted upwardly, the terminal pins 202 move the upper terminal 241 in the upward direction to a predetermined distance, and at this time, the terminal pins 202 are separated from the lower end of the support slit 251. After the terminal pins 202 are separated from the lower end of the support slit 251, when a user rotates the fluorescent lamp 201 at a predetermined angle and draws out the terminal pins 202 through the receiving slit 252, the fluorescent lamp 201 can be easily disassembled from the socket 220.

As described above, the socket according to the present invention can be applied to fluorescent lighting fixtures of all kinds using fluorescent lamps.

As described above, the present invention can prevent discontinuation of illumination of connected portions even though the fluorescent lighting fixtures are aligned in series, thereby providing beautiful outward appearance and improved illumination effect.

Furthermore, the present invention provides excellent durability, because the fluorescent lighting fixtures are simply connected one another by means of the connector and firmly connected one another by means of the combining means.

Moreover, according to the improved socket structure, the fluorescent lamp can be easily assembled and disassembled.

In addition, because the fluorescent lamp is not rotated and not easily separated from the socket, the present invention can prevent an unexpected accident and damage of the fluorescent lamp due to drop of the fluorescent lamp.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fluorescent lighting fixture comprising:
a fluorescent lamp having a tube type lamp body, auxiliary tubes mounted at the tops of both ends of the lamp body, and terminal pins inwardly formed at an end of each of the auxiliary tubes;
a body having a stabilizer mounted therein for lighting the fluorescent lamp, and connection terminals located at both ends thereof at a predetermined interval and electrically connected with the stabilizer; and
sockets mounted at both ends of the body, each of the sockets having a support slit formed in the outer surface thereof for fixing and supporting the terminal pins of the fluorescent lamp, and a receiving slit for allowing the terminal pins to be inserted into the support slit.

2. A fluorescent lighting fixture according to claim 1, further comprising a connector connected to the connection terminal for supplying the external power source to the stabilizer, the connector including: a connector body of a predetermined length; a coupling terminal protruding downwardly from an end of the connector body; and a power cord mounted at the other end thereof.

3. A fluorescent lighting fixture according to claim 1, further comprising a connector for connecting neighboring connection terminals with each other and supplying power source when the bodies of the plural fluorescent lighting fixtures are continuously connected, the connector including: a connector body of a predetermined length; and coupling terminals protruding downwardly from both ends of the connector body.

4. A fluorescent lighting fixture according to claim 1, further comprising a connector for connecting neighboring connection terminals with each other and supplying power source when the bodies of the plural fluorescent lighting fixtures are continuously connected, the connector including: a pair of separate bodies, a coupling terminal protruding downwardly from an end of each body; and an electric wire connected to the other end of each body.

5. A fluorescent lighting fixture according to claim 2, further comprising combining means for combining the connector with the connection terminal of the body of the fluorescent lighting fixture without separation.

6. A fluorescent lighting fixture according to claim 5, wherein the combining means includes: support jaws protruding outwardly from a side of the socket; and combining parts slidably coupled with the body of the connector, each combining part having a locking jaw matched with the support jaw.

7. A fluorescent lighting fixture according to claim 5, wherein a reinforcing bracket is mounted between the lamp body and the auxiliary tube.

8. A fluorescent lamp socket comprising:
a main body;
first bodies connected with a stabilizer by electric wires;
second bodies fixed to both ends of the main body in a state where each second body contains each first body therein, the second body having a support slit formed at a side thereof for fixing and supporting the terminal pins of a fluorescent lamp, and a receiving slit inclinedly formed at a side of the support slit for allowing the terminal pins of the fluorescent lamp to be inserted into the support slit; and
contact means mounted in a mounting hole formed in the first body in a state where the contact means is connected with the electric wires, and elastically connected with the terminal pins.

9. A fluorescent lamp socket according to claim 8, wherein the contact means includes: a lower terminal fixed to the lower end of the mounting hole; and an upper terminal separated from the lower terminal at a predetermined interval and vertically moving by means of an elastic member mounted on the upper end of the mounting hole.

10. A fluorescent lamp socket according to claim 9, wherein the lower terminal and the upper terminal respectively have receiving recesses formed on the corresponding surfaces thereof for receiving the terminal pins of the fluorescent lamp.

11. A fluorescent lamp socket according to claim 9, wherein the mounting hole has support jaws formed at both sides thereof, and the upper terminal has locking jaws formed at both ends thereof to be caught by the support jaws and to maintain the predetermined interval from the lower terminal.

12. A fluorescent lamp socket according to claim 9, wherein the first body has a connection plate for electrically connecting the elastic member and one of the wires.

13. A fluorescent lamp socket according to claim 2, wherein the first body has a receiving slit formed at the corresponding position of the receiving slit of the second body for receiving the terminal pins of the fluorescent lamp between the lower terminal and the upper terminal.

14. A fluorescent lamp socket according to claim 8, wherein the support slits and the receiving slits of the second bodies are directed inwardly when the second bodies are mounted at both ends of the main body.
